(19) United States
(12) Patent Application Publication
(10) Pub. No.: US 2025/0300504 A1
(43) Pub. Date: Sep. 25, 2025

(54) ELECTRIC MACHINE STAR DISC

(71) Applicants: HIRSCHVOGEL HOLDING GMBH, Denklingen (DE); PVS-KUNSTSTOFFTECHNIK GMBH & CO. KG, Niedernhall (DE)

(72) Inventors: Alexander KLOSE, Unterdießen (DE); Daniel FABER, Denklingen (DE); Viktor RICHTER, Untermeitingen (DE); Thomas KOTZARIDIS, Forchtenberg (DE); Alexander GRAMLICH, Schöntal-Bieringen (DE); Rolf KRÄMER, Buchen-Eberstadt (DE)

(73) Assignees: HIRSCHVOGEL HOLDING GMBH, Denklingen (DE); PVS-KUNSTSTOFFTECHNIK GMBH & CO. KG, Niedernhall (DE)

(21) Appl. No.: 19/065,798

(22) Filed: Feb. 27, 2025

(30) Foreign Application Priority Data
Mar. 22, 2024 (DE) 102024108352.2

(51) Int. Cl. H02K 1/24; H02K 11/20; H02K 15/026; H02K 15/121; H02K 15/40

(52) U.S. Cl. CPC H02K 1/24; H02K 11/20; H02K 15/026; H02K 15/121; H02K 15/40

(57) ABSTRACT

A star disc, for a rotor of an electric machine, comprising a plurality of pole arms configured to wind a wire around a winding; a switching ring having protruding contacts, the switching ring being held in a rotationally fixed manner in a recess of the star disc; and an external plastic overmolding structured to hold the switching ring to the star disc in an axially form-fitting manner.

### CROSS-REFERENCE TO RELATED APPLICATIONS

This application claims priority to German patent application No. DE 10 2024 108 352.2, filed Mar. 22, 2024, the disclosure of which is hereby incorporated in its entirety by reference herein.

### TECHNICAL FIELD

The disclosure relates to a star disc for a rotor of an electric machine, which has (pole) arms intended to be wound with wire to form a winding. The star disc includes a switching ring from which contacts, used for connecting to the wire of the winding, project axially. The switching ring is held in a rotationally fixed manner, for example, via form-fitting and/or material bonding, in a (centering) recess, cut-out, or centering diameter of the star disc. The star disc includes a plastic overmolding. The disclosure also relates to an electric machine including the star disc and a method for manufacturing the star disc.

### BACKGROUND

According to the state of the art, specifically DE 10 2022 110 466 A1, a star disc and a method for manufacturing a star disc are already known, where the star disc is produced via a forging process. This publication discloses a method for manufacturing a disc-shaped solid-formed component, particularly for producing a star disc for an electric motor. In the finished state, the solid-formed component extends along a main plane of extension and has at least one essentially radially extending web section relative to an axis perpendicular to the main plane of extension. The method comprises solid forming a starting body, where the starting body has a primary area (which includes at least one radially extending web section of the solid-formed component) and a secondary area, and removing the secondary area, for example, via machining or alternatively via a punching process, to at least partially expose the at least one web section, particularly to expose a central area of the web section.

From DE 10 2021 122 066 A1, a star disc for a rotor of an externally excited synchronous machine is known, where at least the surface of the star disc is made of plastic in which current bars for connecting rotor windings are embedded via injection moulding, and the star disc has contacting elements at both ends for receiving winding wires, which protrude from the surface of the star disc.

From DE 10 2013 004 659 A1, a switching ring for an electric machine and an electric machine with such a switching ring are known. The switching ring has at least one electrically conductive switching ring element with multiple contact points for electrical connection to partial windings of a stator or rotor of the electric machine, and optionally at least one connection point for external electrical connection. The switching ring has an insulating coating comprising a polymer, produced via an electrodeposition process.

### SUMMARY

The object of the present disclosure is to provide a star disc that improves the positioning of the contacts, facilitates high insulation quality, is less complex to manufacture, and offers particularly high stability.

This is achieved by the star disc having an external (two-part) plastic overmolding or encapsulation that fixes, holds, or secures the switching ring to the star disc in the axial direction via a form fit. This eliminates the need for separate or additional fastening of the switching ring to the star disc, as the switching ring is held in place by the plastic overmolding itself. This also provides numerous manufacturing advantages, as separate fasteners and assembly processes can be avoided.

Advantageous embodiments are claimed in the dependent claims and are explained in more detail below.

The switching ring can be manufactured via injection moulding and may have one or more bridges embedded in plastic. The bridge can have one or more contacts. Preferably, the bridge is embedded in the plastic that forms the switching ring. The bridge can be designed with (integral) contacts, where the bridge is largely or extensively covered with plastic, leaving only the contacts exposed. This ensures that the switching ring is electrically insulated except for the contacts, preserving its functionality. The contact can be a winding contact or a slip ring contact, and it may be a crimping fork or a soldering contact.

A bridge can be understood as a component that serves as a current rail. Such current rails are typically made of a material with good electrical conductivity such as aluminium or copper.

As an example, it is advantageous if the star disc has a star disc base body that forms the star-shaped arms, or has them, or geometrically defines them. Preferably, these arms of the star disc base body have head sections at their free ends that extend in the circumferential direction on both sides. Ideally, the arms and head sections are designed in an anchor-like shape in cross-section. Due to the high rotational speeds expected during operation, forces, particularly centrifugal forces, act on the star disc. Therefore, it is advantageous to use steel as the material for the star disc, as a steel star disc base body, particularly a forged one, can effectively compensate the forces encountered during operation.

It is suitable for the plastic overmolding to have a section that overlaps the switching ring as a cover, ring, ring section, or tab. Preferably, the switching ring is overlapped radially on the outside, i.e., on an outer side in the axial direction, and optionally in the radial direction. In the case of a cover, the plastic overmolding can rest against the circumference of the switching ring in the axial direction and overlap the surface of the switching ring in the axial direction. This allows for the design and embedding of the switching ring in the plastic overmolding, which covers the switching ring in the axial direction along the circumference on its front side. In the case of a ring, the switching ring can rest against the circumference of the switching ring in the axial direction in the form of a wall. This enables the design and embedding of the switching ring in the plastic overmolding, covering the switching ring along the circumference on the outside.

Furthermore, the switching ring can have a geometry with recesses and elevations extending in the axial direction, as well as projections or bulges and recesses extending in the radial direction, such that predetermined sections of the switching ring are completely, predominantly, partially, or partly covered by parts of the plastic overmolding. The recesses and elevations on the switching ring allow for the omission of material unnecessary for the switching ring's function, thus saving weight. The elevations facilitate the simplified arrangement of the switching ring in an overmolding tool. The elevations preferably form a centring geometry that aids in the relative arrangement. The projections make it easier to align the switching ring on the star disc. The projections can be offset by 180° in the circumferential direction. The recesses can be arc-shaped or semicircular, preferably running from radially outward to radially inward. The projections can have an underside that rests in the axial direction on a surface of the star disc base body. Preferably, at least some of the projections have an elevation that is covered in the axial direction by the plastic overmolding. This ensures that the switching ring is particularly stable and can be held securely.

Moreover, the outer side of the switching ring can have a form fit and optionally a material fit with the plastic overmolding. The switching ring is held on the star disc via the form fit and optionally the material fit. For a form fit, various contours or shapes are possible, which can be realized, for example, using the previously described recesses and optionally with further separate shapes.

An advantage is achieved if the switching ring is radially centred in a receptacle on an outer side of the star disc base body, preferably a front outer side or front side. The receptacle can be in the form of a stepped notch or groove in the axial direction. In addition to centring, this facilitates the positioning of the switching ring on the star disc. Furthermore, the design of the receptacle makes it easier to cover the switching ring with the plastic overmolding, as the receptacle can form a space where the plastic overmolding can accumulate and adhere to the switching ring.

Additionally, the switching ring can have one branch channel or preferably three branch channels distributed around the circumference. Preferably, the branch channels are arranged at equal distances from each other in the circumferential direction. The branch channels can be arranged in the circumferential direction at the positions of the preferably arc-shaped recesses. The individual branch channels can extend at least partially in the radial direction, preferably from radially outward to radially inward, in the switching ring. A part of the plastic overmolding can be arranged in the branch channels, which holds the switching ring on the star disc. The branch channel is designed for the secure positioning of the bridges in the production of the switching ring (via plastic overmolding). The branch channels are preferably filled when the plastic overmolding is formed, or are completely filled or closed, so that the switching ring is held or fixed to the star disc via the plastic overmolding. In other words, the branch channel serves not only for the sheathing or durability of the plastic overmolding, but also for the secure positioning of the bridges in the overmolding process for the production of the switching ring.

Another advantage is provided if the star disc base body is designed with an aperture for receiving an anti-rotation projection on the switching ring. In other words, a poka yoke solution can be provided for position assurance of the switching ring before overmolding and for assembly in the steel star disc. Preferably, the anti-rotation projection extends axially in a different direction than the contact. This means that the switching ring can have the contacts on the front side (facing away from the star disc base body) and the anti-rotation projection on the rear side (facing the star disc base body). The anti-rotation projection may have a star-shaped contour or a cross-section in the shape of a circle, rectangle, or polygon. A pin-like design is also possible.

The switching ring can preferably have one or, alternatively, several anti-rotation projections. Each anti-rotation projection allows the switching ring to be positioned on the star disc base body without the switching ring shifting undesirably in the circumferential direction. This ensures that the switching ring is held in the correct position for the manufacturing process when the star disc is being produced using plastic overmolding.

It is suitable to position a sheet, preferably a sheet stack formed from multiple individual sheets stacked in the longitudinal direction, between two star discs arranged at a distance from each other. The two star discs, arranged at a distance from each other in the axial direction, are preferably designed differently. A first star disc is designed with a switching ring, as described above, while a second star disc is designed with a plastic ring without contacts. The two star discs, together with the laminated core arranged between them, can form a rotor. In this design, the winding wire is preferably wound around two star-discs in the longitudinal direction.

The disclosure also relates to an electric machine with a rotor comprising a star disc, as described above, and a stator that interacts with the rotor during operation. Such electric machines can be operated as motors or generators. In principle, the star disc design can also be theoretically applied to a stator design.

The disclosure also relates to a method for manufacturing a star disc, preferably as described above, where in a first step, a star disc base body is created for the star disc. After that, a switching ring with axially protruding contacts (but with its contact-free front side) is placed on the star disc base body (directly or indirectly, i.e., with the interposition of one or more components). In doing so, a distance and a minimum thickness of insulation between the steel star disc and the electrically conductive contacts are maintained to reduce or eliminate the risk of flashovers or short circuits. Then, a plastic overmolding (directly or indirectly, i.e., with the interposition of one or more components) is applied over the surface of the star disc base body and at least part of the switching ring in such a way that the switching ring is fixed to the star disc base body in the axial direction. This process simplifies the production of the star disc, as a separate production step for attaching the switching ring to the star disc is no longer necessary.

The switching ring can be manufactured in a preliminary step via injection moulding, using one or more bridges as inserts. In other words, one or more bridges can be encapsulated in plastic to form the switching ring. The contacts, preferably made of copper, are coated or embossed with silver solder, allowing for efficient electrical contact with a connecting component.

The position and/or orientation of the star disc base body and the switching ring are determined by an (overmolding) tool.

The star disc base body can be preheated.

It is more convenient to cast the star disc body first and then machine it or to mill or turn it out of a solid piece.

It is advantageous if the switching ring is filled in a partial area with a branch channel filling. The branch channel filling is preferably applied radially inward. With the help of the branch channel filling, the switching ring can be secured to the star disc base body. This ensures rotation in the circumferential direction and axial retention.

In other words, the disclosure relates to a star disc made of steel, which is machined from a formed part, cast, or machined from a solid material.

The star disc has a plastic overmolding in a two-part design, with a switching ring or a switching ring with copper contacts and a subsequent or separate overmolding. The copper contacts can be designed with stamped silver solder, where these copper contacts are overmolded with plastic, preferably separately from the star disc, as a separate component forming the switching ring. The copper contacts are positioned in an injection moulding tool for production. The finished overmolded switching ring has a flat contact surface, an external diameter, and a pin or anti-rotation projection for aligning and securing the switching ring in the star disc (for the overmolding process). In the subsequent overmolding process, the switching ring is positioned on the star disc and connected to the star disc with a form-fitting plastic connection.

In other words, the disclosure relates to the following process: the bridges can be pre-moulded and/or pre-assembled together with the switching ring in the exact position. They can form the “switching ring” assembly. This assembly can have at least one defined centring geometry that engages with the overmolding tool of the star disc to ensure the reproduced positional accuracy. The star disc base body can be preheated and centred by the overmolding tool. Thanks to the centering of the star disc base body and the switching ring in the overmolding tool, the relative position of the star disc base body and the switching ring can also be precisely positioned.

The switching ring can also be referred to as a contact switching ring. The bridges can also be referred to as contact bridges. The star disc base body can also be referred to as a steel insert or star disc.

Various advantageous embodiments of the disclosure are explained in more detail below with the aid of a drawing comprising several figures.

### BRIEF DESCRIPTION OF THE DRAWINGS

FIG. 1 is an exploded view of the star disc according to the disclosure,

FIG. 2 is a longitudinal sectional view of the star disc in the manufactured state according to the disclosure,

FIG. 3 shows the star disc in a perspective front view with a plastic overmolding,

FIG. 4 shows the star disc in a perspective front view without a plastic overmolding,

FIG. 5 shows the star disc in a perspective rear view without a plastic overmolding,

FIG. 6 shows the switching ring in a front view,

FIG. 7 shows the switching ring in a perspective rear view, and

FIGS. 8A-8C are perspective views of various bridges.

### DETAILED DESCRIPTION

The figures are schematic in nature and are intended solely to aid understanding of the disclosure. The same elements are labelled with the same reference signs. Features of the individual embodiments can be exchanged among one another and used alternatively or cumulatively.

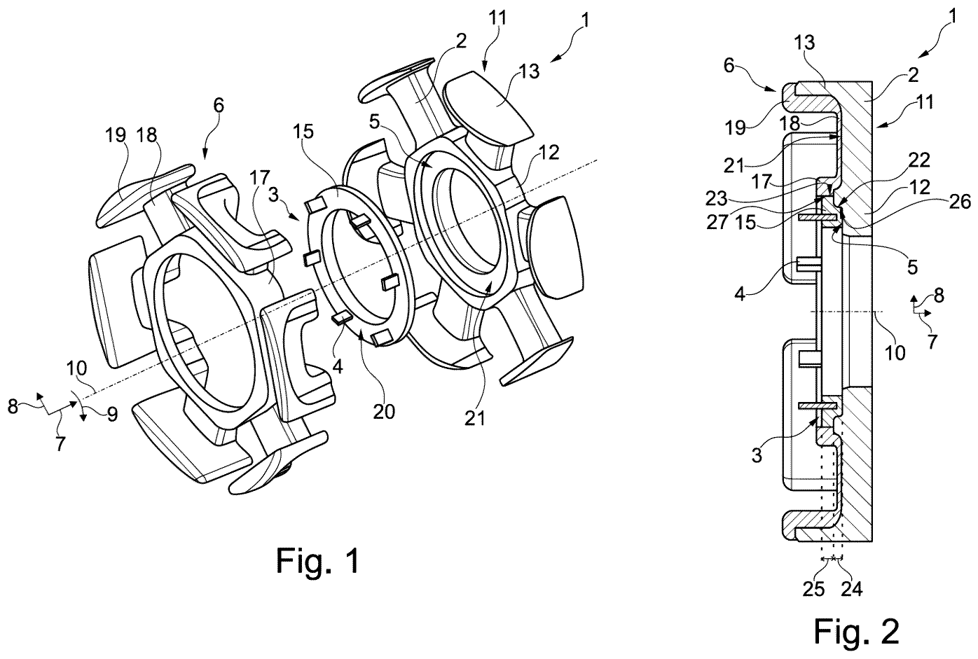

FIG. 1 shows the star disc (1) for a rotor of an electric machine (not shown), the star disc (1) having pole arms (2) that are intended to be wound with wire of a winding, with a switching ring (3), from which contacts (4), i.e., contacts for making contact with the wire of the winding, project axially, the switching ring (3) being held in a rotationally fixed manner in a recess (5), or centring recess, or centring diameter of the star disc (1). It should be emphasised that the star disc (1) has a plastic overmolding (6) on the outside, which fixes the switching ring (3) to the star disc (1) in an axially positive manner in the axial direction (7), or retains it, or fastens it.

FIG. 1 shows an exploded view of the star disc in a schematic view.

To provide better clarity, a radial direction (8) and a circumferential direction (9) are defined in addition to an axial direction (7). The axial direction (7) extends in the direction of a centre axis (10) of the star disc (1). The radial direction (8) is aligned perpendicularly to the axial direction (7). The circumferential direction (9) describes the direction of rotation of the rotor in which the star disc (1) is arranged.

The star disc (1) has a star disc base body (11) on one side. This star disc base body (11) in turn has an annular base body (12), which has pole arms (2) distributed in the circumferential direction (9), arranged evenly in relation to one another and projecting outwards in the radial direction (8). A total of six pole arms (2) are shown in the present diagram, whereby a pole arm (2) follows every 60° in the circumferential direction (9).

Each pole arm (2) has a head section (13) that extends in a radial direction (8) and is plate-shaped on the pole arms (2). The head section (13) and the pole arms (2) are of anchor-shaped cross-section. The ring-shaped base body of the star disc base body (12) has, axially on the front side, a recess (5) in the form of an annular step or notch extending in the axial direction (7), in which the switching ring (3) is positioned.

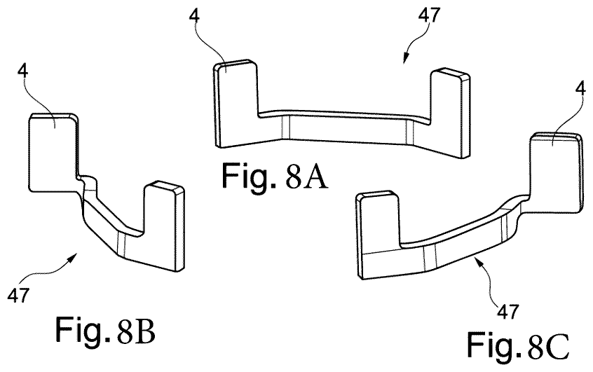

The switching ring (3), arranged on the front side of the star disc base body (11), has a base body (15) made of plastic, which is provided by a plastic overmolding, from which contacts (4) project on the front side in the axial direction (7). The contacts (4) are formed on a bridge (47), with three embodiments being shown in FIGS. 8a, 8b, and 8c in a perspective view.

On the front side of the switching ring (3), a total of six contacts (4) are arranged in the circumferential direction (9) at equal distances from one to another. The contacts (4) can be designed in the form of blocks. They are shown in purely schematic form and other designs are conceivable. The contacts (4) are made of a material separate from the plastic.

The plastic overmolding (6) is positioned in the axial direction (7) at the front side of the star disc base body (11). The plastic overmolding (6) has a similar design to the star disc base body (11). The plastic overmolding (6) has an annular base body (17), which has pole arms (18) that are distributed in the circumferential direction (9), aligned uniformly with one to the other and extend outwards in the radial direction (8). In FIG. 1, a total of six pole arms (18) are shown, whereby a pole arm (18) is arranged in the circumferential direction every 60°. Each pole arm (18) has a head section (19), which is plate-shaped in the radial direction (8) on the pole arms (18). The head section (19) and the pole arms (18) are anchor-shaped in cross-section. There are, of course, as many pole arms (2) as there are pole arms (18).

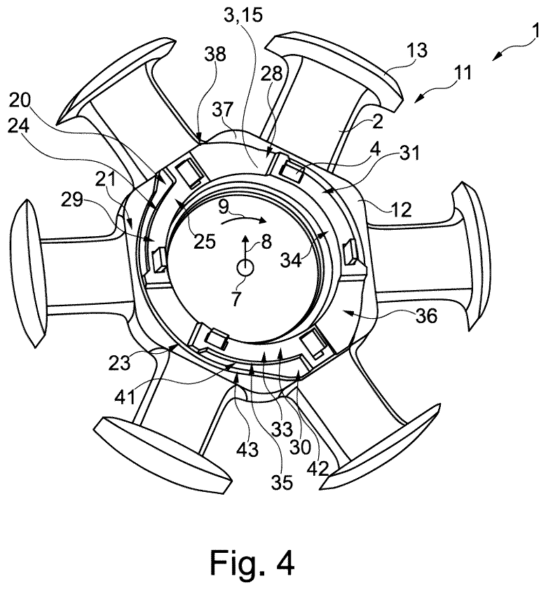

The plastic overmolding (6) is designed to rest with its back side at least partially against a surface (20) of the front side of the switching ring (3) (see FIG. 4) and a surface (21) of the front side of the star disc base body (11).

In FIG. 2, a sectional view of the star disc (1) is shown in the assembled state. The switching ring (3) is positioned in the recess (5). The switching ring (3) has an annular counter-step (22) on the axial rear side that matches the step forming the recess (5), which is formed further out on the switching ring (3) and passes through an outer side (23) of the switching ring (3) on the circumference. The counter-step (22) is designed in the form of a bevel or step. The switching ring (3) thus has two levels (24, 25).

The first level (24) of the switching ring (3) hereby relates to the part of the switching ring (3) which is positioned in the recess (5). The second level (25) of the switching ring (3) describes how the switching ring (3) rests against the frontal surface (21) of the star disc base body (11).

The plastic overmolding (6) lies against the switching ring (3) and the star disc base body (11). The plastic overmolding (6) is designed in such a way that it rests against the free outer side (23) of the switching ring (3), which is not covered by an inner side (26) of the recess (5) of the star disc base body (11). The ring-shaped base body (17) of the plastic overmolding (6) lies radially on the inside, with its inner side or inner wall or inner lateral surface (27) at least partially on the free outer wall, or outer lateral surface, or outer side (23) of the switching ring (3), and holds the switching ring (3) in a form-fitting manner on the star disc base body (11). The plastic overmolding (6) extends in the axial direction (7) beyond the switching ring (3).

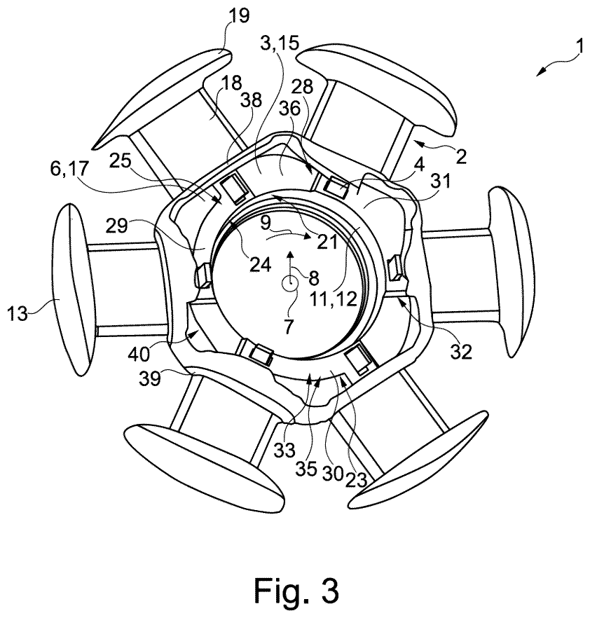

In FIG. 3, a specific design of the star disc (1) with an arranged switching ring (3) and plastic overmolding (6) is shown.

The switching ring (3) has, on the front side, recesses (28) and raised portions (29, 30, 31), which run in sections in the circumferential direction (9) and are formed in the axial direction (7). These recesses (28) and raised portions (29, 30, 31) are formed on the second plane 25 of the switching ring (3). The recesses (28) and raised portions (29, 30, 31) alternate circumferentially (9) with each other in an alternating manner.

In the present design, a total of three recesses (28) and three elevations (29, 30, 31) are configured. In the sections of the elevations (29, 30, 31), the contacts (4) are arranged.

In the circumferential direction (9) between an elevation (29, 30, 31) and a recess (28), a step (32) is shaped which forms a transition from the elevation (29, 30, 31) to the recess (28) and replace from the recess (28) to the elevation (29, 30, 31). Three directly adjacent steps (32) in the peripheral direction (9) each form a centering geometry of the switching ring (3) in an injection moulding tool that facilitates the production of the plastic overmolding (6).

A branch channel (33) is formed in the elevations (29, 30, 31) from radially outwards to radially inwards. The branch channel (33) has a straight extension in the radial direction (8) and a rectangular cross-section. The branch channel (33) is limited to penetrating the outer side (23), while the branch channel (33) does not penetrate the inner side or inner wall (34) of the switching ring (3). The branch channel serves not only to encase and reinforce the plastic overmolding, but also to ensure that the bridges are correctly positioned in the plastic overmolding process of the switching ring. The inner side (34) of the switching ring (3) has three to six recesses to ensure that the plastic overmolding process of the switching ring (3) is carried out correctly.

On the outer side (23), at the position of elevation (29, 30, 31), a radially inwardly extending arcuate or semi-circular first indentation or first recess (35) is formed with a radius, which is aligned symmetrically to the branch channel (33) in the circumferential direction (9). The first recesses (35) penetrate the outer side (23) of the switching ring (3).

In the recesses (28), there are also a second indentation or second recess (36), which is curved or semi-circular and extends radially inwards, with a radius. The second recesses (36) penetrate the outer side (23) of the switching ring (3).

The switching ring (3) has two first projections (38) extending in the radial direction (8). The projections (38) are aligned at 180° to one another in the circumferential direction (9). The projections (38) are formed partly on an elevation (29, 30) and partly on a recess (28) in the radial direction (8). A contact (4) is positioned on that section of the projection (38) of the elevation (29, 30).

The design of the plastic overmolding (6) is made from the axial direction (7) according to a cover (39). The second level 25 of the switching ring (3) is embedded in the plastic overmolding (6) on the circumference. The above-described branch channels (33) are filled with the plastic overmolding (6). The recesses (35, 36) are filled in a contour-shaped manner, that is not fully voluminous in the radial direction (8). In the plastic overmolding, (6) apertures or free spaces (40) are formed in a circular shape. This means that one area is free of plastic overmolding (6). In accordance with the circular shape of the free spaces (40) and the arrangement of these, the contour-shaped filling of the first and second recesses (35, 36) is formed by the contour of the free spaces (40) in the plastic overmolding (6). The plastic overmolding (6) is designed to be flat at the front in relation to the recesses (28) and elevations (29, 30, 31).

The pole arms (2) and the head sections (13) of the star disc base body (11) are covered on the surface side with the plastic overmolding (6).

FIG. 4 shows the star disc (1) with a switching ring (3) without a plastic overmolding (6). FIG. 4 shows further recesses (41) that were previously hidden by the plastic overmolding (6). The switching ring (3) has further recesses (41, 42) and projections (43) in addition to the first projections (38) and first and second recesses (35, 36) described above. On the radially outer side of the switching ring (3), in the sections of the raised portions (29, 30, 31), there are formed partial sections with third recesses (41), which extend in sections in the circumferential direction (9). At the same time, a second projection (43) is formed in these partial sections, which extends in sections in the circumferential direction (9). Further, fourth recesses (42) are formed on the first projections (38) in the circumferential direction (9) towards the adjacent branch channel (33).

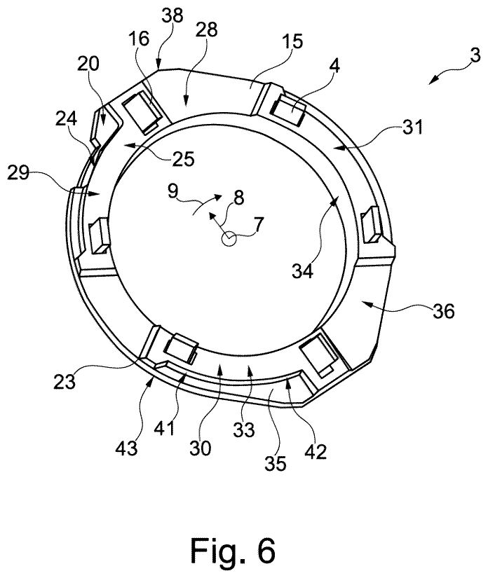

A single view of the switching ring (3) according to an equal perspective is shown in FIG. 6.

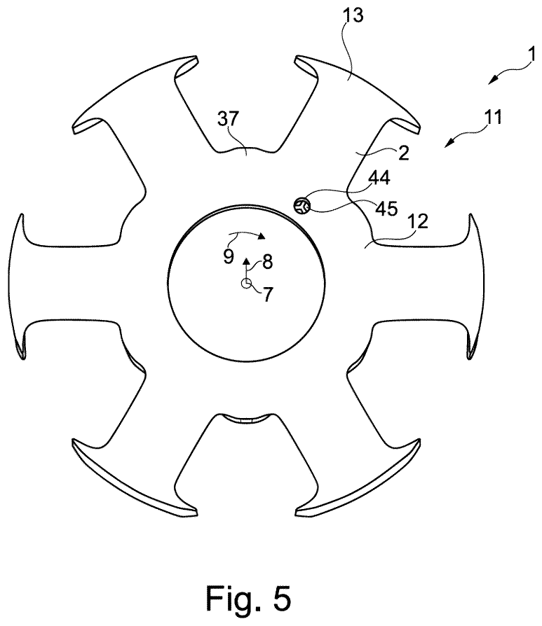

FIG. 5 shows a rear view of the star disc (1) according to FIG. 4 on the star disc base body (11). The star disc base body (1) has a planar rear side surface. The star disc base body (11) has a single axial through-hole (44) on the ring-shaped base body of the star disc base body (12), with an anti-rotation projection (45) partially entering the through-hole (44) in the axial direction (7). The anti-rotation projection (45) is formed on the rear side of the switching ring (3). The contour of the anti-rotation projection (45) is star-shaped.

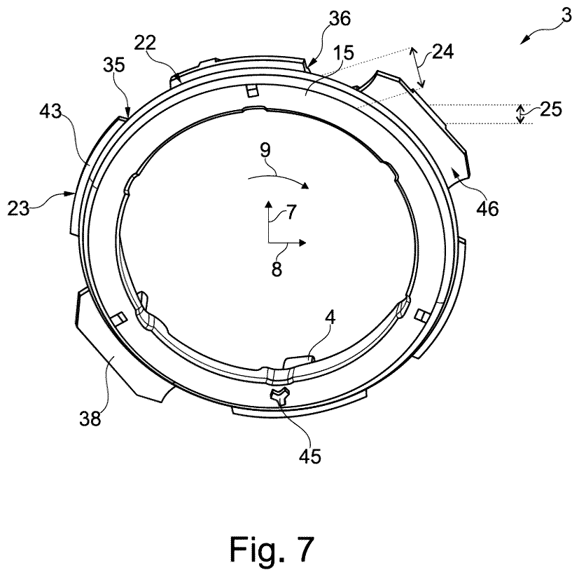

FIG. 7 shows a rear view of the switching ring 3. In FIG. 7, the switching ring (3) is shown in a perspective rear view. In FIG. 7, the complete design of the two levels (24, 25) of the switching ring (3) can be seen. The previously described projections (38, 43) are formed on the second level (25) and extend in sections in the radial direction (8) along the circumferential direction (9). FIG. 7 clearly shows that the first projections (38) extend further in the radial direction (8) than the second projections (43). The first projections (38) and second projections (43) have an underside (46) that is intended to rest against the surface (21) of the star disc base body (11), namely, the surface of the ring-shaped base body of the star disc base body (12). The anti-rotation projection (45), which has already been described, is also shown in FIG. 7. The first level (24) of the switching ring (3) is designed to be ring-shaped and constant in the circumferential direction (9).

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCE DESIGNATION LIST

1 Star disc
2 Pole arm
3 Switching ring
4 Contact
5 Recess
6 Plastic overmolding
7 Axial direction
8 Radial direction
9 Circumferential direction
10 Center axis
11 Star disc base body
12 Base body of the star disc base body
13 Head section
15 Base body of the switching ring
17 Base body of the plastic overmolding
18 Pole arm of the plastic overmolding
19 Head section of the plastic overmolding
20 Surface of the switching ring
21 Surface of the star disc base body
22 Counter-step
23 Outer side of the switching ring
24 First level of the switching ring
25 Second level of the switching ring
26 Inner side of the recess of the star disc base body
27 Inner side of the plastic overmolding
28 First recess
29 First elevation
30 Second elevation
31 Third elevation
32 Step
33 Branch channel
34 Inner side
35 First recess
36 Second recess
38 First projection
39 Cover
40 Free space
41 Third recess
42 Fourth recess
43 Second projection
44 Through-hole
45 Anti-rotation projection
46 Underside
47 Bridge

What is claimed is:

1. A star disc, for a rotor of an electric machine, comprising:
a plurality of pole arms configured to wind a wire around a winding;
a switching ring having protruding contacts, the switching ring being held in a rotationally fixed manner in a recess of the star disc; and
an external plastic overmolding structured to hold the switching ring to the star disc in an axially form-fitting manner.

2. The star disc according to claim 1, wherein the switching ring is an injection molding switching ring with one or more bridges embedded in plastic.

3. The star disc according to claim 1, wherein the star disc has a base body that forms the plurality of pole arms which are star-shaped.

4. The star disc according to claim 1, wherein the external plastic overmolding has a section overlapping the switching ring as a cover, ring, or tab.

5. The star disc according to claim 1, wherein the switching ring has a geometry including recesses and elevations extending in an axial direction and projections and recesses extending in a radial direction such that predetermined sections of the switching ring are partially or completely covered by parts of the external plastic overmolding.

6. The star disc according to claim 1, further comprising a form fit and optionally a material fit with the external plastic overmolding on an outer side of the switching ring.

7. The star disc according to claim 3, wherein the switching ring is centred in a receptacle on an outer side of the base body.

8. An electric machine comprising:
a rotor having a star disc comprising
a plurality of pole arms configured to wind a wire around a winding;
a switching ring having protruding contacts, the switching ring being held in a rotationally fixed manner in a recess of the star disc; and
an external plastic overmolding structured to hold the switching ring to the star disc in an axially form-fitting manner; and
a stator that co-operates with the rotor during operation.

9. The electric machine according to claim 8, wherein the switching ring is an injection molding switching ring with one or more bridges embedded in plastic.

10. The electric machine according to claim 8, wherein the star disc has a base body that forms the plurality of pole arms that are star-shaped.

11. The electric machine according to claim 8, wherein the external plastic overmolding has a section overlapping the switching ring as a cover, ring, or tab.

12. The electric machine according to claim 8, wherein the switching ring has a geometry including recesses and elevations extending in an axial direction and projections and recesses extending in a radial direction such that predetermined sections of the switching ring are partially or completely covered by parts of the external plastic overmolding.

13. The electric machine according to claim 8, further comprising a form fit and optionally a material fit with the external plastic overmolding on an outer side of the switching ring.

14. The electric machine according to claim 10, wherein the switching ring is centred in a receptacle on an outer side of the base body.

15. The electric machine according to claim 8, wherein the electric machine is a motor.

16. A method for producing a star disc, the method comprising:
(a) providing a star disc base body having a plurality of pole arms configured to wind a wire around a winding;
(b) placing a switching ring, having protruding contacts that project axially, on the star disc base body; and
(c) applying a plastic overmolding over a surface of the star disc base body and over at least a portion of the switching ring such that the switching ring is fixed to the star disc base body in an axial direction.

17. The method according to claim 16, further comprising producing the switching ring by injection molding prior to step (a).

18. The method according to claim 16, wherein a positions and/or orientation of the star disc base body and of the switching ring are determined by a tool.

19. The method according to any one of claim 16, wherein the star disc base body is preheated.

20. The method according to claim 16, wherein the switching ring is filled with a branch channel filling.
